(19) United States
(12) Patent Application Publication
(10) Pub. No.: US 2010/0017870 A1
(43) Pub. Date: Jan. 21, 2010

(54) MULTI-AGENT, DISTRIBUTED, PRIVACY-PRESERVING DATA MANAGEMENT AND DATA MINING TECHNIQUES TO DETECT CROSS-DOMAIN NETWORK ATTACKS

(75) Inventor: Hillol Kargupta, Ellicott City, MD (US)

Correspondence Address: Kakali Sarkar, 4413 Whispering Willow Drive, Ellicott City, MD, 21043, US

(73) Assignee: AGNIK, LLC

(21) Appl. No.: 12/175,453

(22) Filed: Jul. 18, 2008

(51) Int. Cl. G06F 21/00; G06F 15/16

(52) U.S. Cl. 726/14; 709/201; 726/23; 726/26

(57) ABSTRACT

The present invention is a method and a system that uses privacy-preserving distributed data stream mining algorithms for mining continuously generated data from different network sensors used to monitor data communication in a computer network. The system is designed to compute global network-threat statistics by combining the output of the network sensors using privacy-preserving distributed data stream mining algorithms.

This application claims the benefit of U.S. Provisional Application No. 60/959,699, filed Jul. 17, 2007, which is hereby incorporated by reference in its entirety.

### FIELD OF INVENTION

The present invention relates to multi-agent systems and privacy-preserving distributed data stream mining of continuously generated data in computer network systems for detecting network threats.

### BACKGROUND OF INVENTION

No methods currently exist for multi-agent, distributed, privacy-preserving data mining for detecting attacks or threats of attacks in computer networks of multiple organizations or multiple domains within an organization (called cross-domain network threat management, hereafter). Existing network monitoring technology works by exchanging the raw network-data generated by various network sensors (e.g. intrusion detection systems, firewalls, virus, spyware and various malware detection systems) within an organization before the data can be analyzed.

In today's world defending the networked computing environment is extremely important. Network attack detection and prevention systems (e.g. intrusion detection systems, firewalls, virus, spyware and various malware detection systems) are playing an increasingly important role in doing that. However, these systems usually work in a stand-alone fashion with little or no interaction among each other in a networked environment. The firewall of one organization does not interact with the firewall of another organization. Even within the same organization, these network sensors do share information with each other.

PURSUIT overcomes these issues by allowing the analysis of attack patterns against heterogeneous sets of sensors across domain boundaries using distributed, privacy-preserving data mining techniques. PURSUIT uses data from coalition members in privacy-sensitive manner so that no potentially sensitive data will be divulged to other coalition members or a third party.

Using data mining techniques for sensing network intrusion is a known art. However, there is no software for linking different network threat detection sensors and analyzing the data from these sensors using distributed, privacy-preserving data mining techniques.

For instance, U.S. Pat. No. 6,931,403 is directed toward a system and method for perturbing the original data followed by transferring the perturbed data to a web site, and mining the perturbed data using a decision tree classification model or a Naive Bayes classification model while preserving a user's privacy which is taken care of by perturbing the user-related information at the user's computer. At the Web site, perturbed data from many users is aggregated. From the distribution of the perturbed data, the distribution of the original data is reconstructed. The model is being provided back to the users, who can use the model on their individual data to generate classifications that are then sent back to the Web site such that the Web site can display a page appropriately configured for the user's classification. Although this patent mine the user's data in a privacy-preserving way, perturbed data leaves the user's computer and the patent does not talk about data collected from different domains or producing a collective results in a distributed fashion from different domains where data may never leave the users' computers.

U.S. Pat. No. 6,694,303 is again directed to a system and method for perturbing the data for maintaining users' privacy using Gaussian or uniform probability distribution and mining the perturbed data to build a model after sending the perturbed data to a Web site. The patent does not mine the data in a distributed fashion, neither it mines any cross-domain network data.

U.S. Pat. No. 6,546,389 is directed to a system and method for mining data while preserving a user's privacy includes perturbing user-related information at the user's computer and sending the perturbed data to a Web site. At the Web site, perturbed data from many users is aggregated, and from the distribution of the perturbed data, the distribution of the original data is reconstructed, although individual records cannot be reconstructed. Based on the reconstructed distribution, a decision tree classification model or a Naive Bayes classification model is developed, with the model then being provided back to the users, who can use the model on their individual data to generate classifications that are then sent back to the Web site such that the Web site can display a page appropriately configured for the user's classification. Or, the classification model need not be provided to users, but the Web site can use the model to, e.g., send search results and a ranking model to a user, with the ranking model being used at the user computer to rank the search results based on the user's individual classification data.

Prior state-of-the-art is based on analyzing data from individual sensors. This technology does not work for cross-domain network threat management since most organizations do not want to share raw, unprotected network data traffic with other organizations because of privacy and security reasons.

There exists need for cross-domain systems that link network sensors (e.g. intrusion detection systems, firewalls, virus, spyware and various malware detection systems) from different organizations or different domains within the same organization. Such systems must be able to support analysis of the data from all the sensors without sharing the raw unprotected data and thereby protecting the privacy of the data from different domains.

### SUMMARY OF THE INVENTION

PURSUIT is a computer network detection and prevention system operating across organization and system boundaries without risking privacy-sensitive data due to its use of state-of-the-art privacy-preserving distributed data mining (PPDM) technology. Using coalitions of different organizations or different domains within the same organization, PURSUIT can support early detection and reaction to threats against the computer network and related resources. PURSUIT has a distributed multi-agent architecture that supports formation of ad-hoc peer-to-peer, hierarchical, and other collaborative coalitions with due attention to the security and privacy issues. It is equipped with PPDM algorithms so that the patterns can be computed and shared across the sites in a privacy-protected manner without sharing the privacy-sensitive data. The algorithmic foundation of the approach is based on combination of pattern-preserving algorithms for secured multi-party computation, mathematical randomized transformations, and communication-efficient distributed data mining algorithms that allow detection of cross-domain attack patterns, without sharing the raw, unprotected data.

The PURSUIT system uses emerging privacy preserving distributed data mining (PPDM) research to allow accurate analysis and mining of the distributed data from coalition members using privacy-transformed pattern-preserving representations. Simply speaking, it allows detecting threats against coalition members while preserving utmost privacy of the data owner. Privacy of the data is completely controlled by the owner. The data is never revealed unless the owner explicitly allows it. PURSUIT supports policy driven privacy protection and specification of privacy policy in a computer readable markup language.

PURSUIT offers a complete middleware solution for comprehensive threat management within an organization. It allows many threat analytics-related features, including the following capabilities:
Distributed attack (e.g. port scan) detection and trend analysis.
Detect stealth probes and worms on your network that fall below the threshold monitored by your traditional intrusion detection and prevention systems.
Collect data on attackers to build up identifying “signatures” of the attackers.
Form coalitions that look for attack patterns across all the coalition members. These patterns can be any function of the network traffic data: (1) information about a specific communication (e.g. source ip address, destination ip address, time) and (2) information about the content of the packets.

The current invention offers major improvement in capabilities on two grounds:
Linking the data from different network sensors and supporting the analysis using privacy-preserving data mining algorithms. This technology guarantees privacy protection based on the policy-specified by the data owner.
Minimizing the amount of data communication using distributed data mining technology. This makes sure that the system is scalable to large consortiums comprised of many organizations and the response time is fast.

The current system has five components. The first component (LIP Agent) is an interface between the network sensor and the PURSUIT system. It collects data from the sensor and feeds that to the Pursuit Agent of the PURSUIT system.

The second component is the Pursuit Agent which deploys the privacy-preserving data mining algorithms. It runs in the local machine of a participating organization and manages communication with other Pursuit Agents running at other organizations. It also supports user interaction and privacy-specification through a graphical user interface.

The third component is the CAM Agent which is in charge of several Pursuit Agents running at different organizations that belong to the same coalition. This component is in charge of managing the overall computation involving all the Pursuit Agents. The CAM Agents generates the final result of the distributed, privacy-preserving data mining algorithms and stores those in a local database.

The fourth component is the PURSUIT Web Service. This component presents the results that the CAM Agent produces through a web-based user interface. This web-interface can also be used for creating and managing PURSUIT coalitions.

The fifth component is an optional collaboration management module that allows the users from different organizations to collaborate about threats against the different network-assets that they would like to protect. This component allows posting of notes, various types of files, and archiving the discussion in an information retrieval engine in the form of cases. These archived cases can later be searched, retrieved, and compared with other cases.

### BRIEF DESCRIPTION OF DRAWINGS

FIG. 1 Venn Diagram Showing the Relationship Between Privacy Sets.

FIG. 2. The PURSUIT System Architecture.

FIG. 3. The Pursuit Agent user interface.

FIG. 4. Collaborative Environment Module Architecture.

FIG. 5. Multi-Organizational Collaboration Management Module.

FIG. 6. The PURSUIT Web Services Architecture.

FIG. 7. PURSUIT Web-service showing the attack statistics for the entire coalition over a time period.

FIG. 8. PURSUIT Web-service showing the worm-attack statistics for the entire coalition over a time period.

FIG. 9. Conceptual illustration of the k-zone of privacy framework.

FIG. 10. (Left) Inner product matrix (measure of similarity) computed by comparing the IP addresses in their original form. (Right) Same computed from their privacy-preserving representations.

FIG. 11. Data flow diagram of the distributed inner product computation.

FIG. 12. Detection of spatio-temporal distribution of attack trends.

FIG. 13. Distribution of attacks common between UFL and UMN on 2004/12/09.

### DETAILED DESCRIPTION OF THE PREFERRED EMBODIMENTS

PURSUIT technology can be used in software that interfaces with an existing Intrusion Prevention and Detection System (IPDS) deployed on computer networks. PURSUIT takes data from the IPDS, and transforms it in such a way that the data-patterns can be extracted and shared without divulging the data. Each PURSUIT plug-in is under total control of the organization deploying it. The data patterns in PURSUIT are not shared with the entire Internet, but only with a specific PURSUIT coalition that the organization joins. The coalition may be the branch offices of a company, a set of companies, or a large hierarchical organization like the Department of Homeland Security. Each coalition determines its own enrollment requirements to ensure the coalition is serving each members needs.

PURSUIT coalition can be organized in three different ways:
Hierarchical: This is for large organizations (e.g. global companies or Government Departments) that have many independent networks. PURSUIT provides a way for them to monitor attack trends across the entire enterprise.
Peer-to-peer: This model is used by a loosely cooperating set of companies or organizations (e.g., coalitions of financial services companies, power companies or universities) to share data. Individual members get better information about current attacks which provides them with more effective IDS.
Centralized: This model is used by loosely coupled organizations (e.g., a coalition formed by the Department of Homeland Security with state and local first responders) with central coordination of coalition resources for analyzing the bigger picture.

The main distinguishing characteristics of the PURSUIT technology are as follows:
1) Privacy-preserving data stream mining for network data analysis: Privacy-preservation of the organization and individual users while allowing advanced distributed data analysis for network intrusion detection and prevention plays a critical role in PURSUIT. The privacy preserving data mining technology is based on various algorithms designed using frameworks like the k-zone of privacy, secured multi-party computation (SMC), and multiplicative transformation. The approach addresses the scalability problem of SMC and possible privacy-breaching problems of random perturbation-based techniques. All the used techniques come with analytical proofs of their correctness which guarantee that the released information cannot be traced back to the source data and the related organization within the acceptable level privacy-protection.
2) Distributed data analysis algorithms that minimize communication cost and therefore offer a more scalable system with faster response time: These algorithms analyze data in a distributed fashion by minimizing the communication cost resulting in a better scalable system. Since a cross-domain network-threat detection system needs to handle large number of participating organizations, centralized privacy-preserving algorithms are unlikely to scale up. PURSUIT technology is based on distributed data mining algorithms.
3) End-to-end solution for network threat detection and collaborative threat management with human-in-the-loop: The distributed collaborative decision support environment built on top of a searchable information retrieval engine (with historical case archiving support) will facilitate the collaborative threat detection and digital evidence collection process.

### Privacy Definitions in PURSUIT

No cross-domain network threat detection system can be successful and widely accepted unless it seriously deals with the privacy of the data. Therefore, preserving privacy is of utmost importance in PURSUIT. An organization participating in a PURSUIT coalition must have full control over what information about the organization is released to rest of the coalition. PURSUIT allows coalition members to divide the different data attributes available from the IDPS systems among the following privacy categories:
Member Public—Data that is easily publicly available, and is shared freely within the coalition and the general public. Examples include: Publicly available IP addresses, Name of the organization, Description of organization (sector, size, region, etc.), Organization-contact information.
Coalition Public—Data approved for sharing among coalition members, but not with the public at large. This data will not be obscured by privacy-preserving techniques, but it may be encrypted when the members communicate on public networks.
Coalition Private Shareable—Data released only when used in privacy-preserving data mining operations. This data may be revealed upon request when it is believed to represent suspicious activity. This data is treated the same as Coalition Private data otherwise.
Coalition Private—Data released only when used in privacy-preserving data mining operations. It may not be revealed on request even if it is believed to represent suspicious activity.
Member Private—Data that may not be released outside the organization under any circumstances. This data may not be used in privacy-preserving data mining operations.

All data types that are classified as Coalition Private may be configured as Coalition Private Shareable by a coalition member. The coalition member may decide to allow some sensitive data to be revealed in the presence of suspicious activity and under proper legal requests. The coalition member has full control over what data may be released, and when it may be released. The Coalition Private/Coalition Private Shareable boundary may be configured using sophisticated rules. For example, a user may configure the Source IP Address of an attack to be Coalition Private Shareable, except when the IP address is within some specific range of IP addresses. The range of IP addresses could represent a business partner that the organization member does not wish to make publicly known.

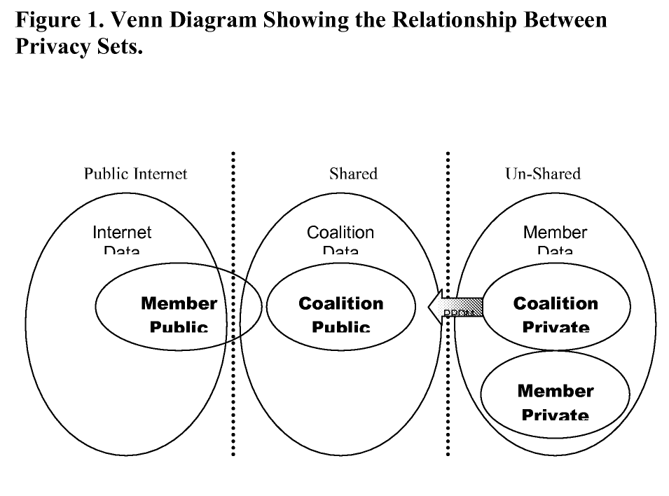

FIG. 1 shows the relationship among the available Privacy Sets. Note that the Coalition Private data patterns can only be shared though privacy-preserving data mining techniques. Table 1 shows a possible privacy set configuration of some example attributes of typical network traffic flow. This is just one possible scenario, presented to illustrate the privacy control mechanisms offered by the PURSUIT system.

Once a member participating in a PURSUIT coalition selects a privacy policy and assigns the attributes obtained from the IDPS sensors among different privacy sets, the next step is to allow analysis of the data within the privacy constraints. In order for the PURSUIT system to deal with the cross-domain data from different organizations in a distributed environment it requires a scalable system for supporting distributed privacy-preserving analysis of the multi-party data. The following section describes the architecture of PURSUIT.

TABLE 1
An example of different privacy levels assigned to the network-traffic
attributes.

Coalition Public
Size of packet
Lifetime of packets
Packet ID
TCP sequence number
TCP acknowledge number
TCP flags (including SYN, ACK, FIN, RST, etc.)
Additional flags available from IDS
Flags for other packet types (ICMP, UDP, etc.)
Coalition Private
Source IP address
Destination Port number
Protocol (TCP, UDP, ICMP, etc.)
Service (HTTP, MAIL, etc.)
Payload content type identified by IDS
IDS Alarm Status
Time interval between similar events
Frequency of packets (packets from a particular source or to a particular
destination, out of all packets seen by IDS)
Member Private
Destination IP address
Payload content

### 3.1.3 PURSUIT High Level Architecture

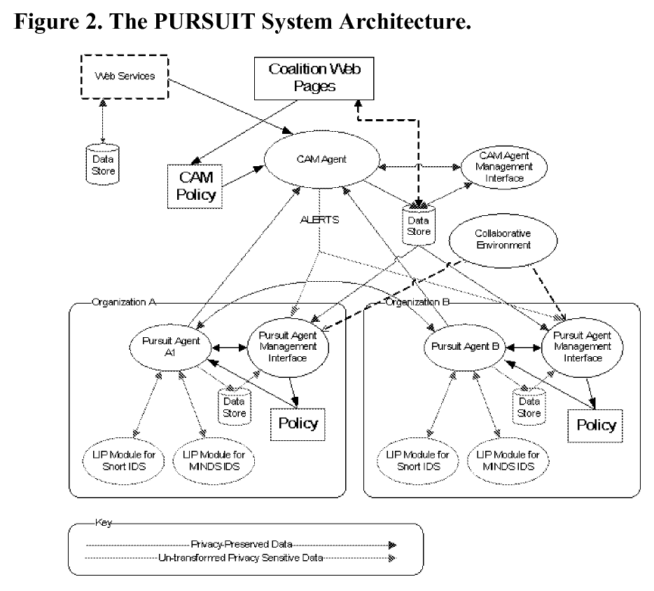

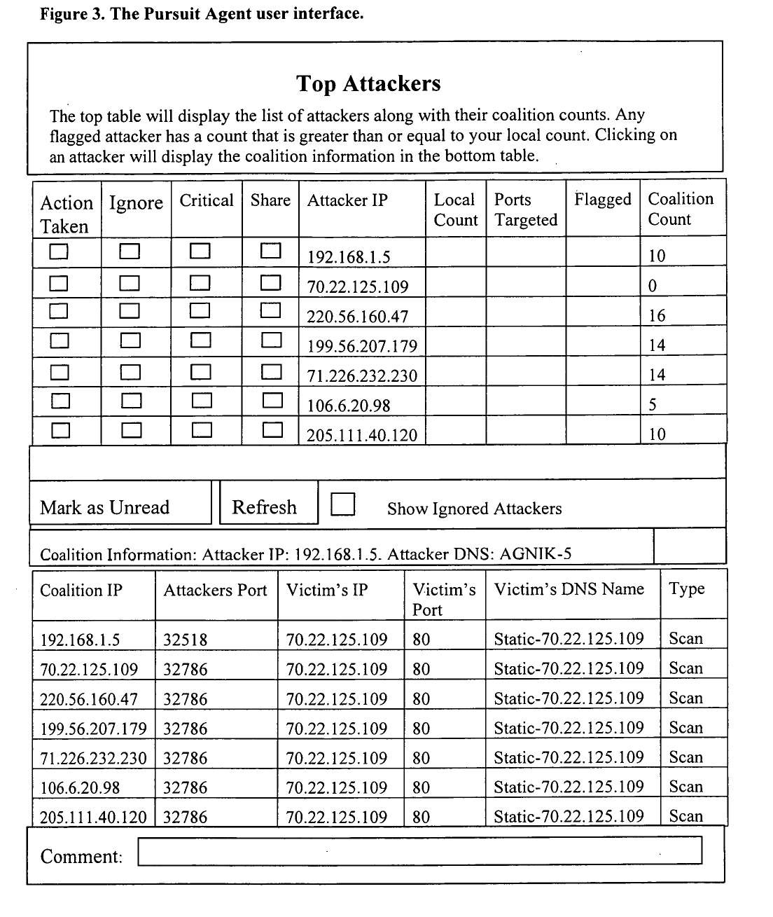

FIG. 2 shows the overall architecture of the PURSUIT system. It is comprised of the software components described in the following sections.

### 3.1.3.1. LIP Module

The Local IDPS Plug-in (LIP) modules are responsible for extracting and managing the data from the local IDPS systems. The LIP module is the middleware between a local IDPS system and the PURSUIT network. LIP modules to support different IDPS systems will be developed as part of the PURSUIT system. The LIP modules are lightweight components; they do little or no data analysis related computation, and no privacy-preserving transformation. The LIP modules do not communicate with any entity outside their local network.

The LIP module supports data extraction from the particular IDPS in to a format understood by the Pursuit Agent. The LIP module will supply the data in a format best suited for the particular IDPS system supported by that LIP module. Some examples of these formats follow:
1. Raw network-traffic LIP data includes Cisco netflow-like features, including source IP/port, destination IP/port, protocol, time, duration, packet counts, byte counts, etc.
2. Snort IDS data includes source IP/port, destination IP/port, protocol, time, packet content, Snort attack identifications, etc.
3. MINDS IDS portscan detection data includes netflow-like data including source IP/port, destination IP/port, protocol, time, duration, packet counts, byte counts, anomaly scores, etc.
4. Firewall IDS data includes source IP/port, destination IP/port, time, packet contents, protocol.
5. Additional supported IDS/IPS systems will include additional data as available from the particular IDS/IPS system

### 3.1.3.2. Pursuit Agent

The Pursuit Agent receives data from one or more LIP. The IDPS systems and LIP modules need not be located on the same physical machine, or within same physical subnet as the Pursuit Agent. However, because of the bandwidth requirements of a LIP module, particularly on medium to large size networks with high traffic levels, it may be desirable to pay particular attention to the available bandwidth between the LIP module and Pursuit Agent devices. It is also possible to run the Pursuit Agent on the same physical machine as the LIP module and IDPS systems, eliminating any practical bandwidth considerations. Unlike the LIP module, the Pursuit Agent does require some computation power, so this configuration may not be desirable for medium to large size networks. Communication between the LIP module and the Pursuit Agent is encrypted, as required. Clearly if they are operating on the same machine the encryption is not necessary, as no traffic will leave the machine. In other situations, where the traffic crosses an unsecured network, it is desirable for this communication stream to be secured as it contains data in its original, non-privacy protected state.

The Pursuit Agent is responsible for performing the privacy-preserving local analysis of available input data, and communicating with the CAM agent, and other Pursuit Agents in the same coalition. All of these exchanges will be across an open and unsecured network, so all communication is both authenticated and encrypted. No data not explicitly allowed by an organization's privacy policy is ever released outside the organization by the Pursuit Agent. The Pursuit Agent can be thought of as the filter that prevents privacy sensitive data from leaving the organization without undergoing privacy-preserving transformations.

### 3.1.3.3. CAM Agent

The Cross-domain Attack Manager (CAM) Agent receives data from the Pursuit Agents participating in the coalition. The CAM Agent also provides the computational power required by some of the algorithms. Some of the supported algorithms require a centralized site within the coalition to compute portions of the algorithm, and some operate in a truly peer-to-peer manner and forward only the results to the CAM Agent.

All the data, models and patterns held by the CAM Agent have already undergone privacy-preserving transformations. No data that is not expressly allowed to be released according to the privacy policies of a participating organization is ever forwarded to the CAM Agent.

The CAM Agent is the component of the PURSUIT system that has the highest computational resource requirements. Techniques such as load balancing and resource sharing among coalition members can be included in the CAM Agent to support efficient resource utilization in large coalitions.

### 3.1.3.4. Pursuit Agent Management Interface

The Pursuit Agent Management Interface allows an administrator with an organization participating in a PURSUIT coalition to manage their local Pursuit Agent(s). The Management Interface will provide the following functions in a graphical user interface:
1. Definition of privacy policies for organization data.
2. Control local Pursuit Agents, start/stop/restart functions, show operational status, coalition membership status, etc.
3. Assignment of local LIP Modules to a Pursuit Agent.
4. View local IDPS results; recall historical result data.
5. Share local results and historical result data using the Collaborative Environment.
6. Compare local results with coalition results; compare historical data.

The Pursuit Agent Management Interface allows users to join a Collaborative Environment. Within the Collaborative Environment the user can choose to share data and confirm attacks for forensic or other purposes. All of these exchanges are controlled directly by the user so that no private data will leave the organization without direct action by the user. The Collaborative Environment is described in detail below.

### 3.1.3.5. CAM Agent Management Interface

The CAM Agent Management Interface provides different functions depending on the user. Different roles can be assigned to authorized users of the software. These roles include
1. Administration privileges for a CAM Agent: start/stop/restart agent, obtain operational status report, etc.
2. Coalition result view privileges: view the coalition results including models and patterns obtained from the coalition-wide privacy preserving data mining algorithms. Note: does not allow viewing or comparison to local coalition member data.

The CAM Agent Management Interface will also allow users that are viewing result data to communicate with the Collaborative Environment. The user may request more information from coalition members about a particular event or alert as required for forensic or other purposes. The Collaborative Environment is described in more detail in the following section.

### 3.1.3.6. Collaborative Environment Module

The objective of the Collaborative Environment Module (CEM) is to facilitate communication between users of the PURSUIT system regarding events, threats and alerts against the coalition and the coalition members. The collaboration module offers a visually interactive environment for communication of the specific data useful for analysis of the current threat against the coalition or a subset of the coalition members. Data and patterns may also be exchanged for use as forensic evidence about a particular attacker against the coalition.

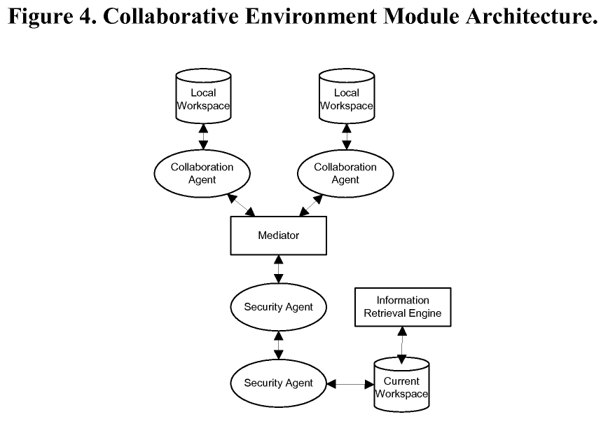

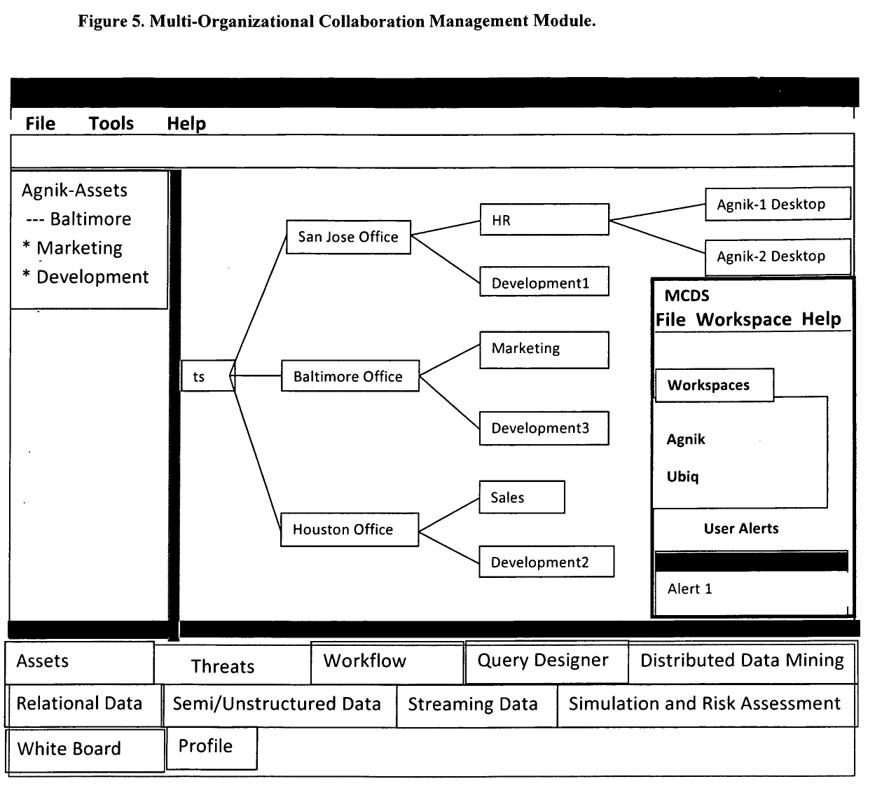

As an example of a potential use of the Collaboration Environment Module, imagine the following scenario: a coalition alert is raised for suspicious activity from a particular source. An administrator wishes to investigate the details of the activity that caused the alert, but the attack targets and other information about the alert is classified as Coalition Private data and has been protected by the privacy-preserving algorithms. The administrator can put the available details of this event into the Collaborative Environment requesting further information. Other coalition member administrators can choose to share additional information about the activity by retrieving data matching the alert from local activity logs that are not directly shared with the coalition. This additional data may help determine the seriousness of the alert based on more detailed analysis, or it could be archived to form a collection of network forensic evidence against the perpetrator. See FIG. 4 for a schematic diagram of the overall architecture of the Collaboration Environment Module.

The CEM allows formation of ad-hoc groups of entities in order to facilitate collaborative problem solving. These entities include members participating in a coalition, as well as users who are authorized to be the data and patterns of the coalition as a while. This module is designed around a collection of capabilities for constructing and maintaining multiple collaborative workspaces. Each workspace is a shared environment where the different entities can post multimedia information for sharing information and discussing the content in order to detect emerging threats against the coalition. The workspace (WS) is a distributed environment where the content is maintained by a server and accessed by the remote interactive browser-clients.

The CEM is implemented using a JADE-based multi-agent platform. Communication between the WS server and the client browsers are supported through Agent Communication Language (ACL). Each collaborator maintains a local copy of the collaborative WS area and any change made to the local copy of the WS, such as posting a new object, following up on an existing object under analysis, links to existing resources, assets, etc. are communicated to the security agent through the Mediator. The Mediator authenticates the collaborating agent, i.e. validates the access to the resources currently edited by the collaborator before updating the global copy shared by all the collaborators. Once the global copy is updated, it is broadcasted to all the participating collaborators triggering an update of their respective local copies of the WS. A centralized copy of the workspace is always maintained at the Server agent, which is provided to any new collaborator joining the collaboration at a later date. The main purpose of the security agent is to provide mechanisms for access control and maintain the overall integrity of the CMM. The content of the WS is represented in the XML format and stored in an Information Retrieval Engine for efficient query processing and retrieval of the data. The WS content description also includes positional information on the various entities present on the workspace. The XML file is decoded to reproduce a visual copy of the workspace, possibly when new collaborators join the collaborative workspace at a later date.

### 3.1.3.7. PURSUIT Web Services

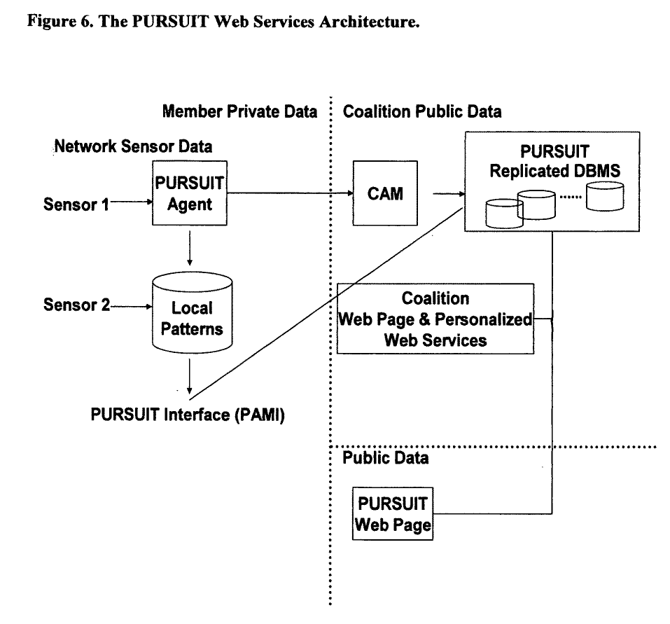

PURSUIT web services will offer a way to manage different coalitions. It will also offer a rich set of personalized services to the coalition members. FIG. 6 shows the architecture of the web services. The web-based user interface is divided into two main components:
1) PURSUIT Administrative Web Pages: These pages are used for administering the PURSUIT coalitions and providing access to the downloadable plug-in modules of the PURSUIT system. New users will be able to signup and form coalitions using this interface. It will also offer a comprehensive introduction to the PURSUIT technology and related documentation for the software.
Coalitions can be created on the PURSUIT web site. It will involve registering the initial CAM Agent for the coalition, and the Coalition Web Service. As more CAM Agents are added to the coalition they will also be added to the registry. A coalition is created through the PURSUIT web page. Entry requirements to join the coalition and other attributes are set during creation. The process will involve several layers of authentication and other security management mechanisms.
2) Coalition Web Page and Personalized Services: These pages will offer coalition and individual user specific services. Each coalition will have its own web page. The coalition web page will allow members to view coalition specific information and attack statistics. Members will also be able to subscribe to coalition-wide intrusion alerts. It will also offer a rich variety of different coalition and individual specific statistics through authenticated secured accounts. Two of these services are further detailed below:
a) View Coalition public data: The CAM Agents store the data patterns they discover in a replicated database. All information stored in the database is Coalition Public. The Coalition Web Page provides a convenient interface to see the data in the database. The user can compute a wide variety of statistics about attacks against the coalition, such as number of stealth probes, total probes, estimated number of groups probing the coalition and frequency. The data will be available in its raw form as well as more visual representations such as graphs and charts. No Member Private Data is ever available through the Coalition Web Page.
b) Subscribing to Alerts: The Coalition Web Page is a passive interface that requires members to visit it to see the data. In order to get more timely information, members can subscribe to a variety of alerts. If the alert condition is met the coalition member is sent email, SMS message, or paged, as desired. Alert conditions include various scenarios such as a large spike in the number of attacks against the coalition in a short time frame

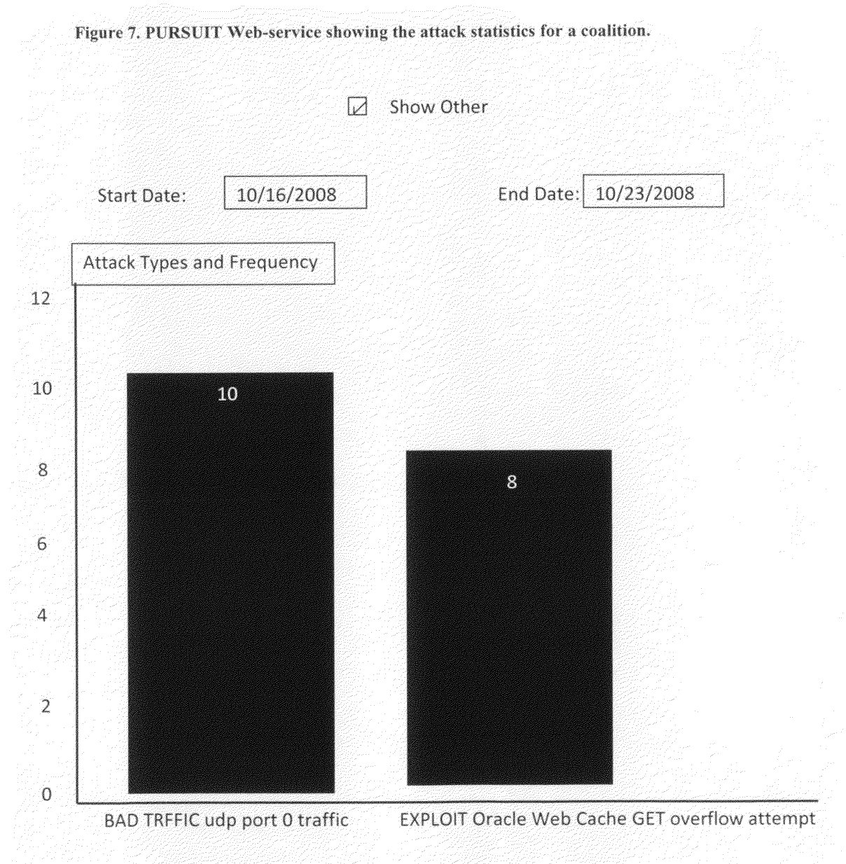

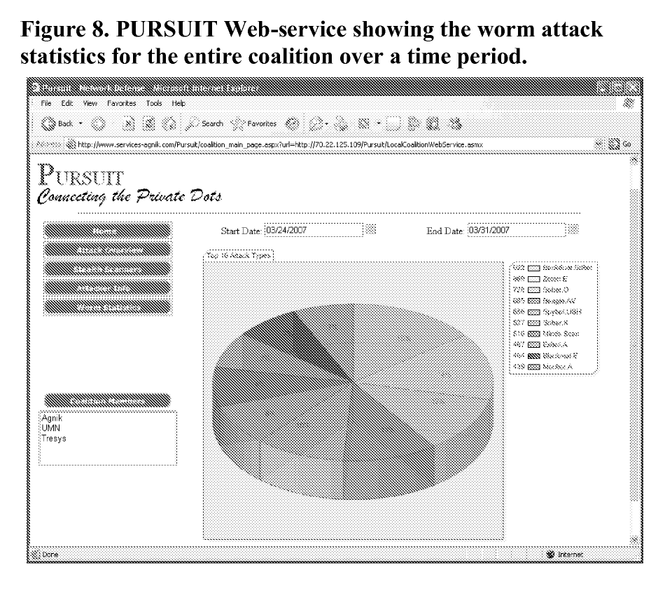

FIGS. 7 and 8 show the interfaces for PURSUIT web-service. Both of them show different ways to visualize aggregate results computed from the information generated by the different members of the coalition using PPDM techniques.

In cross-domain attack detection applications, only approaches that provide privacy will succeed. We also believe that in order to actually find useful network threat patterns one needs a complete rich data set. Simply sharing a few sanitized fields will not yield enough information. PURSUIT guarantees privacy of an entire rich dataset, not just a few fields, allowing better protection from statistical attacks. The following section describes another PPDM framework used in PURSUIT.

### 3.1.4. Privacy Preserving Distributed Data Mining (PPDM) Framework

The PURSUIT system will be designed to detect various types of threats against the networked computing infrastructure of one or more organizations. Services will include the following:
1) Recognizing distributed attacker signatures
2) Detecting attack trends on coalition members
3) Detecting stealth worm activities.
4) Detecting distributed stealth portscan detection.
5) Generating attack statistics on industry, geographic and other factors so that human analysts can better determine intent.

In order to perform these tasks from the cross-domain data we must develop a framework that allows mining the multi-party data in a distributed manner without violating the privacy.

The foundation of the PURSUIT system is laid on the powerful capabilities of the privacy-preserving distributed data mining (PPDM) algorithms (incorporated in the CAM and PURSUIT Agents). PURSUIT enables cross-domain analysis in a distributed manner that will allow detection of patterns without sharing raw privacy-sensitive data. The main distinguishing characteristics of the PPDM technology in PURSUIT are as follows:
Privacy-preserving data mining for network data analysis: This component of the technology allows privacy-preservation of the organization and individual users while allowing advanced distributed data analysis for network intrusion detection and prevention. The privacy preserving data mining technology is based on various algorithms designed using the following frameworks:
   i. the k-zone of privacy,
   ii. secured multi-party computation (SMC), and
   iii. multiplicative transformation.
      The approach addresses the scalability problem of SMC and possible privacy-breaching problems of random perturbation-based techniques.
Distributed data analysis algorithms that minimize communication cost and therefore offer a more scalable system with faster response time: These algorithms allow PURSUIT to analyze multi-party data in a distributed fashion by minimizing the communication cost resulting in a better scalable system. A cross-domain network threat detection system must be able to handle large number of participating organizations and centralized privacy-preserving algorithms are unlikely to easily scale up.

Before we discuss the specific techniques for solving distributed intrusion and other threat detection-related capabilities of PURSUIT, let us first make ourselves familiar with the privacy-preserving distributed data mining frameworks used in PURSUIT.

3.1.4.1. k-Zone of Privacy

K-zone of privacy offers a framework for privacy-preserving data mining that is based on constructing a many-to-one transformation of the data. Algorithms based on this framework usually rely upon constructing a new randomized attribute space that guarantees a high degree of difficulty in estimating the source data, while making sure that the target class of patterns is preserved. The framework shows that it is possible to construct an encoding of the data that allows computation of a target pattern function in an exact manner where the difficulty in breaching the privacy-protection becomes exponentially more difficult with respect of the “size” of the chosen encoding. The foundation of this theoretical construction is based on large random encodings of the data that distributes the information necessary for computing the target function among the different components of the random representation.

Consider the following:

S_{T}={(xᵢ,yᵢ)} and X_{y}_{ᵢ}={xᵢ|(xᵢ,yᵢ) ∈ S_{T}}

$$k = {min}_{i} ‖ {X}_{{y}_{i}} ‖$$

If for all yᵢ we can guarantee

$$\frac{P [ {y}_{i} \vert {x}_{1} ]}{P [ {y}_{i} \vert {x}_{2} ]} \leq γ ∀ {x}_{1} , {x}_{2} ∈ {X}_{{y}_{i}}$$

then transformation T offers a (k, γ)—Ring of Privacy k-Zone of Privacy preserves the underlying pattern needed for threat detection; but it cannot be decoded back to the actual data. More precisely, the degree of difficulty in retrieving the source data offered by this class of PPDM algorithms grows super-exponentially with respect to the size of the new encoding of the data. Since the size of the new encoding is a user chosen parameter, once can always chose that appropriately for achieving the desired level of privacy-protection. Consider the example shown in Table 2 that shows the privacy-preserving encodings (generated based on the k-zone of privacy framework) of three IP addresses that preserve similarity (in the sense of inner product):

TABLE 2
The inner product matrices computed from the original
IP addresses and their privacy-preserving representation
that preserves inner product.

| IP Addresses | Privacy-Preserving Encoding |
|---|---|
| 192.168.0.141 | −44.0442, −144.472, 75.4616, −11.3656, 32.48, |
| | −235.113 |
| 192.168.0.141 | −44.0442, −144.472, 75.4616, −11.3656, 32.48, |
| | −235.113 |
| 70.16.17.195 | 22.9036, −70.1776, 36.5356, −101.842, 115.27, |
| | −114.135 |

### 3.1.4.2. Secure Multi-Party Computation (SMC) Primitives

The basic intent of secure multi-party primitives is to compute some output data given some function on input data that is distributed across multiple mutually distrustful entities. These entities do not wish to reveal their own input data, yet they wish to find the result of the computation. One way to achieve this is to find a trusted third party. Each entity could then give their data to this trusted third party; the third party will then aggregate the data, perform the desired computation, and return the final results, all without revealing any of the intermediate data. Clearly this is a difficult proposition in the real world. Finding a third party that is trusted by all of the entities involved may be an impossible task. The desire to remove any need for a third party is what prompted the development of secure multi-party computations. These algorithms emulate the function of a trusted third party, but to perform all computations within the network of entities. These algorithms generally have certain conditions, such as a majority honest model, which they depend upon to protect the local data held by each entity. An additional concern regarding SMC techniques is to ensure that intermediate data is not revealed. Using sequences of standard SMC techniques in sequence to form the complete desired computation may reveal intermediate data between each of the steps. In some cases this intermediate data may be relatively benign, and in some cases it may be very important to the privacy preservation of the entire algorithm. These are issues that we consider in the creation of our algorithms.

Below we describe a number of secure multi-party computation primitives that we make use of in our privacy preserving data mining algorithms.

### Inner Product Computation Using SMC

The SMC-based approach will be illustrated here using a two party scenario, which can be easily extended to the multi-party scenario. Consider two sites s₁ and s₂ with real-valued row vectors (equally applicable to integer-valued vectors) x₁ and x₂ respectively. We would like to compute the inner product [symbol] x₁,x₂ [symbol] such that s₁ gets v₁ and s₂ gets v₂, where v₁+v₂= [symbol] x₁, x₂ [symbol] and v₂ is randomly generated by s₂. The idea is to divide the inner product into two secret pieces, with one piece going to s₁ and the other going to site s₂.

### Step 1—Generate Random Vectors

The CAM Agent generates two random vectors Rₐ and R_{b} of size n, and let rₐ+r_{b}= [symbol] Rₐ, R_{b} [symbol] , where rₐ (or r_{b}) is a randomly generated number. Then the server sends (Rₐ,rₐ) to s₁, and (R_{b},r_{b}) to s₂.

### Step 2—Compute Intermediate Value

The PURSUIT Agent at site s₁ sends \hat{x}₁=x₁+Rₐ to site s₂, and s₂ sends \hat{x}₂=x₂+R_{b} to site s₁.

### Step 3—Compute Preliminary Results

The PURSUIT Agent at site s₂ generates a random number v₂, computes [symbol] \hat{x}₁, x₂ [symbol] +(r_{b}−v₂), and then sends the preliminary result to s₁ in a peer-to-peer manner.

### Step 4—Compute Partial Results

The PURSUIT Agent at site s₁ computes

( [symbol] \hat{x}₁,x₂ [symbol] +(r_{b}−v₂))− [symbol] Rₐ,\hat{x}₂ [symbol] +rₐ= [symbol] x₁,x₂ [symbol] −v₂=v₁

### Step 5—Compute Final Result

The PURSUIT Agent at sites s₁ and s₂ send v₁ and v₂ to the CAM Agent respectively and the inner product is v₁+v₂.

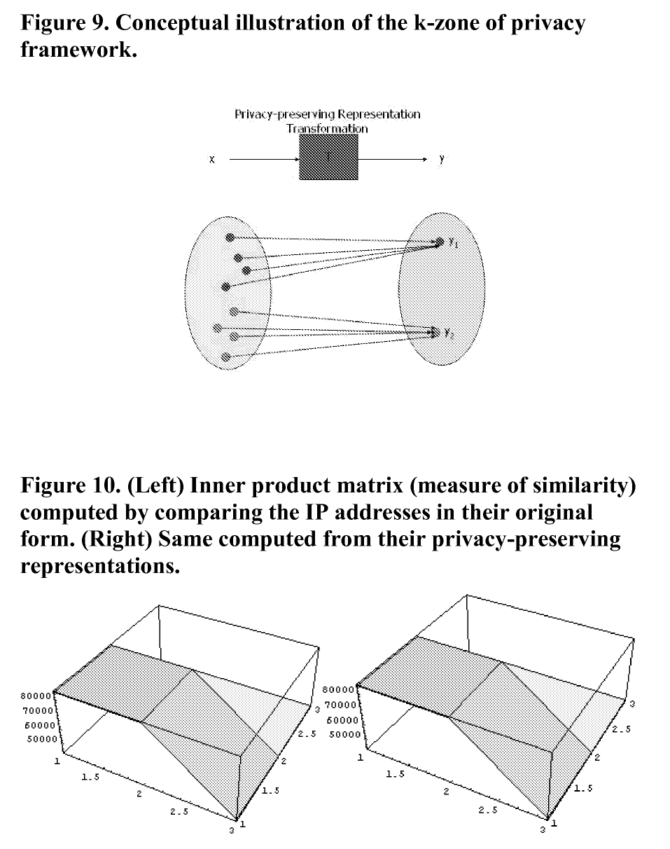

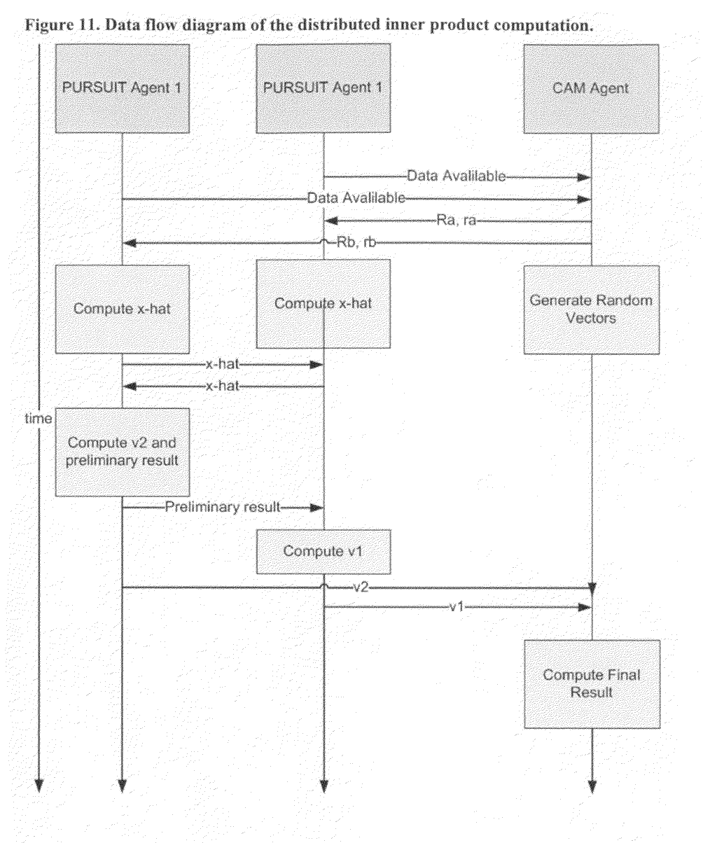

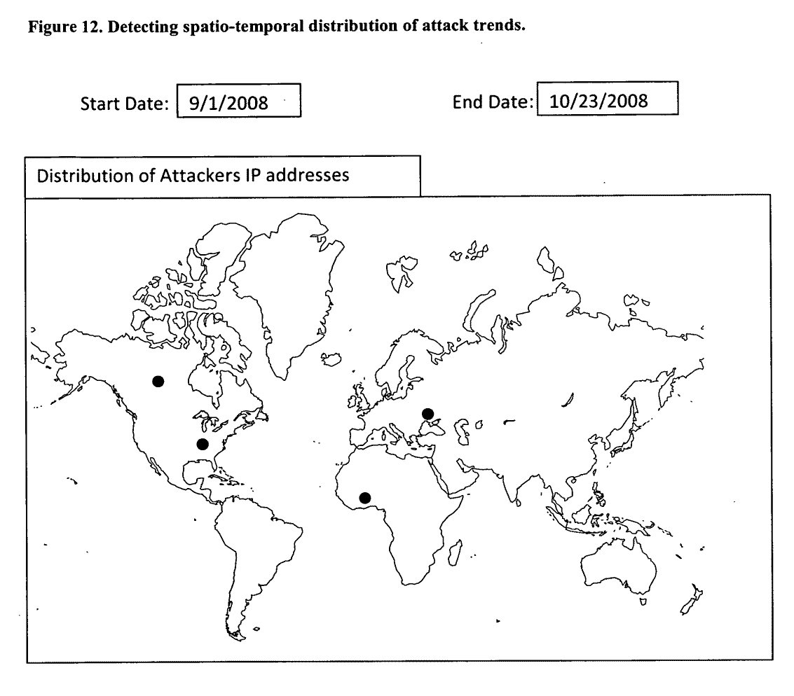

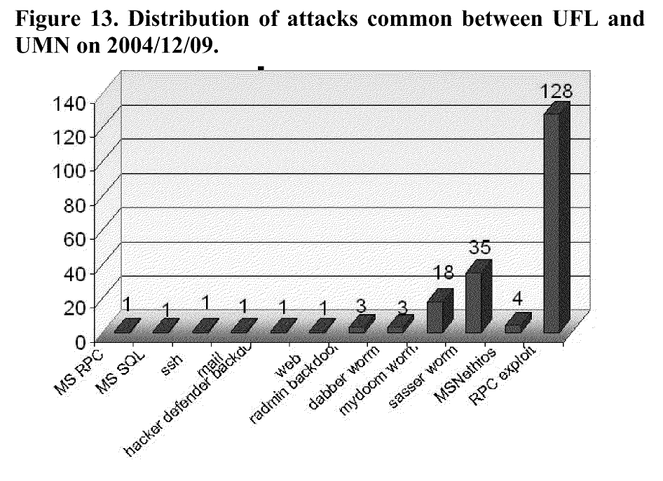

The data flow diagram of the distributed inner product computation is shown in FIG. 9.

### Secure Sum Computation

In the secure sum problem, we wish to compute the sum of a set of numbers. Each number, vᵢ, is held by a different site, sᵢ,i=1,K ,n. These sites wish to compute

$$\hat{v} = {\sum }_{i = 1}^{n} {v}_{i} ,$$

without revealing any vᵢ, and obtaining as a result only \hat{v}. This algorithm is described by Bruce Schneier [10] among others.

The secure sum algorithm operates as follows. Site s₁ is elected to begin the computation. s₁ generates a random number r, chosen from a uniform distribution [0,m]. m is chosen to be greater than the largest possible sum of the computation. Site s₁ then computes r+v₁ mod m and sends the intermediate result v to s₂. Each of the remaining sites, sᵢ compute (v+vᵢ) mod m and send the result to the next site. Thus, each site sᵢ has

$$r + {\sum }_{j = 1}^{i} {v}_{i} mod m .$$

Finally, after the last site computes v, the result is sent back to s₁. s₁ then computes (v−r) mod m to obtain the final result of the summation.

### Privacy Analysis of Secure Sum

The security of this algorithm is based on the modulo operation, which preserves a uniform distribution when each vᵢ is added. Because the distribution remains uniform, no information can be learned about the intermediate v values [6].

This algorithm is subject to attack by colluding sites. Sites sₗ₋₁ and sₗ₊₁ can learn vₗ ; if they share their intermediate results. The difference between these results will yield the exact value of vₗ. This risk can be mitigated for an honest majority. This is accomplished by dividing the total computation into a number of sub-sums. Each value vᵢ is divided into p portions. The secure sum is then performed p times, each with a different permuted order of sites. In the previous case at least 2 sites sₗ₋₁ and sₗ₊₁ must be colluding to learn vₗ. In this case, assuming the permutation works such that site sₗ has different neighbors for each round, 2p colluding sites are required before vₗ can be discovered. Clearly, the value of p can be adjusted to provide security for an honest majority regardless of the number of sites n at the cost of requiring more rounds of computation, yielding higher computational and communication cost.

The main drawback of this algorithm is its synchronous nature. Each site must communicate their local results in order before the algorithm can proceed. Clearly this requires a highly reliable network, which is not always possible.

### Secure Set Union

The secure union finds the set

$$S = {Y}_{i = 1}^{n} {V}_{i}$$

for sites sᵢ,i=1,K, n that each have set Vᵢ. No intermediate Vᵢ is revealed, any element x ∈ S is not confirmed to be x ∈ Vᵢ or x ∉ X Vᵢ. For data sets with large domains, as in our application and privacy preserving data mining tasks in general, this algorithm requires a commutative encryption algorithm, which we briefly describe below.

### Commutative Encryption Using SMC

A commutative encryption algorithm [1,9] is an encryption algorithm E(∵) that any permutation of n keys K₁,K,Kₙ applied subsequently to an input P, yield the same output C. That is:

C=E(K₁,E(K₂,E( . . . E(Kₙ,P)K)))=E(K_{1′},E(K_{2′},E( . . . E(K_{n′},P)K)))

However, the one-way property (polynomial time to encrypt, and no-known polynomial time decryption algorithm without the presence of the original key) is particularly important for this application. Pohlig-Hellman [9] using a shared large prime p, is based on the difficulty of computing the discrete logarithm, is one such algorithm that has these properties.

In short, the secure set union operation makes use of a commutative encryption algorithm that is applied by all participating sites sᵢ to every object xᵢⱼ ∈ Vᵢ for all i,i=1,K,n. The encrypted data are then aggregated, duplicates are removed, and each site sᵢ reverses the encryption algorithm. Finally, the union set is revealed.

### Step 1—Compute Encrypted Version of Vᵢ

At each site, sᵢ, every local objects xᵢⱼ ∈ Vᵢ is encrypted with local key Kᵢ to form E(xᵢⱼ,Kᵢ). We will refer to the set of objects encrypted by Kᵢ rather informally as E(Vᵢ,Kᵢ). E(Vᵢ,Kᵢ) is then transmitted to sᵢ₊₁.

### Step 2—Compute Encrypted Version of E(Vᵢ₋₁,Kᵢ₋₁)

Each site, sᵢ receives E(Vᵢ₋₁,Kᵢ₋₁) from the previous site sᵢ₋₁. sᵢ then performs the same operation on each object in Vᵢ₋₁, again rather informally forming E(E(Vᵢ₋₁,Kᵢ₋₁), (Kᵢ). This process repeats until each site receives the its original Vᵢ encrypted by each of the keys K₁,K,Kₙ. These sets are then set to a single site, sᵢ.

### Step 3—Union and Remove Duplicates

Site s₁ receives every encrypted set. Duplicates are removed and the set is aggregated into a single union set. Because each object xᵢⱼ is encrypted by the same set of keys K₁,K,Kₙ, although in a different order, if xᵢⱼ=xᵢₖ then E*(xᵢⱼ,K*)=E*(xᵢₖ,K*). Duplicates can easily be removed without knowing what the contents are.

### Step 4—Remove Encryption

s₁ removes its encryption using key K₁ from the final encrypted set E*(S,K*). The result is sent from s₁ to sᵢ. sᵢ removes encryption by key Kᵢ, and sends to sᵢ₊₁. After all sites s₁,K,sₙ have removed encryptions using keys K₁,K,Kₙ only the final set

$$S = {Y}_{i = 1}^{n} {V}_{i}$$

remains.
Privacy Preserving k-Means Clustering from Distributed Data

Clustering algorithms have been studied within the privacy preserving data mining community, and the issues involved are well understood. The algorithm described in this section is a privacy preserving k-means algorithm. In the actual algorithm for our data we may require a k-prototypes algorithm [4], which will support integral, categorical, and binary data types. For now let us concentrate on the k-means clustering algorithm for developing a privacy preserving distributed technique.

Recall that the k-means clustering algorithm operates as follows. k points are randomly selected in the feature space. Every item in the set of objects is assigned to one of these k points based on the smallest distance measure (which can be computed in any number of ways; Euclidian, Manhattan, etc.). The new median of each of these clusters is recomputed based on the points that are assigned to it. The algorithm continues iterating assignment of objects and recomputation of clusters until the amount of change within an iteration falls below some minimum threshold.

The privacy preserving k-means algorithm over horizontally partitioned data operates in the same manner, except the objects are distributed across multiple sites, here {s₁,s₂,K,sₙ}. The resulting cluster means (known as centroids) are computed without revealing the actual objects, or what the contribution of each site is to the total set of all objects in the computation.

### Step 1—Generate Starting Centroids

k initial points are generated randomly by the CAM Agent. This set of initial points is transmitted to each of the sites.

### Step 2—Compute Local Centroid Assignments

At each site, sᵢ, the local objects T are assigned to the appropriate centroid Aᵢ based on the distance metric selected. The sites perform this operation in parallel.

### Step 3—Compute Distances

At each site, sᵢ, new means are computed based on the assigned local objects. The number of points contributing to the mean, as well as the summation of the object distances is computed. Again, this computation is performed in parallel.

### Step 4—Compute Means for Coalition

This step makes use of secure sum algorithms. The sum of the local means is computed, separately summing each attribute, as well as the number of objects. The secure sum algorithm is initiated by the CAM Agent. The CAM Agent creates

$$V = \{ \vert i = 0 , K , k , j = 0 , K , {num}_{attributes} \} and$$

$$= \{ {c}_{i} \vert i = 0 , K , k \} .$$

Each xᵢⱼ is initialized with random values, and each cᵢ is initialized with a random value greater than the maximum number of objects the coalition could have. V and [symbol]
are then sent to site s₁. s₁ computes

$${V}_{ij}^{′} = {V}_{ij} + {\sum }_{l = 0}^{\vert {T}_{i} \vert} dist ( {A}_{ij} , {T}_{ijl} )$$

and cᵢ′=cᵢ+|T| for all i,i=0,K,k and j,j=0,K ,num_{attribtes}. V′ and [symbol] are then sent to sᵢ and sᵢ performs the same computation. This operation is performed synchronously by each site, sᵢ. When completed, the final V′ vectors and [symbol] values are transmitted to the CAM agent, which can subtract the original V and [symbol] so that the new mean values can be calculated.

### Step 5—Calculate Termination Condition

If the new calculated means differ from the previous computed means, the means are accepted and the computation is completed. If not, the new means are transmitted as in step 1, and the cycle is repeated.

Privacy Analysis of k-Means Clustering Algorithm

This computation is subject to collusion to learn the local means. This can be mitigated by both permuting the order of transmission, and dividing the local means in some random manner and summing them separately. These issues are fundamental to the secure set sum operation; please see the section concerning the secure sum algorithm for a method of dealing with this risk by maintaining an honest majority.

In this computation, the local objects are not revealed to the CAM agent or other Pursuit Agents, and the local means or number of local objects are also hidden. The final resulting means are known, as well as the total number of objects in the coalition. The actual local data points are never directly or indirectly communicated outside of the local Pursuit Agent. Because all distance computation remains local, there is no need to perform an SMC inner product computation to compute distance metrics.

### 3.4.1.3. Multiplicative Privacy-Preserving Transformation: Inner Product Computation

Different variants of random projection techniques can be used for constructing a privacy-preserving representation of data that also preserves the inner product matrix.

In this technique a randomly generated projection matrix with mean zero and i.i.d. entries is used to project the data to a low dimensional space. Random projection matrices preserve inner product. Let R be a p×k dimensional random matrix such that each entry r_{i,j} of R is independently chosen according to some distribution with zero mean and unit variance. Let x₁′=x₁R and x₂′=x₂R. It is easy to show that the expected value of the inner product E[<x₁′,x₂′>]/k=<x₁,x₂>. Table 3 shows the experimental result for estimating the approximate value of the inner product.

This technique can be used in combination with the SMC-based exact algorithm for efficient approximate computation of the inner product that offers improved scalability. This approximate approach will first apply the random projection transformation and then apply the SMC-based algorithm for computing the inner product in O(k) time, or less than O(n) required by the SMC technique, since k may be chosen to be less than n with only a small loss of accuracy.

TABLE 3
The relative error resulting from the inner product computation
between two binary vectors, each with 10000 elements. k is the
size of the randomly projected space. k is represented as the
percentage of the size of the original vectors. Each entry
of the random matrix is chosen independently from U(1, −1).

| | | Variance of | | Maximum |
|---|---|---|---|---|
| K | Mean Error | the Error | Minimum Error | Error |
| 100(1%) | 0.1483 | 0.0098 | 0.0042 | 0.3837 |
| 1000(10%) | 0.0430 | 0.0008 | 0.0033 | 0.1357 |
| 2000(20%) | 0.0299 | 0.0007 | 0.0012 | 0.0902 |

### Primary Strengths of PURSUIT's Technical Foundation

Most SMC-based algorithms are communication intensive and not very scalable. Moreover, SMC-based PPDM algorithms do not necessarily guarantee privacy-protection from any attack based on the outcome of those algorithms. PURSUIT addresses these shortcomings by blending a collection of techniques from all the three privacy-preserving data mining frameworks discussed so far, namely: (1) k-zone of privacy, (2) SMC, and (3) multiplicative perturbation. The algorithms are also blended with different distributed algorithms wherever appropriate for developing a scalable solution. Next we discuss the specific network threat detection problems and identify the technical approach to address those problems using the PPDM frameworks discussed here.

### 3.1.5. Detecting Network Attacks Using PPDM Techniques

This section discusses some of the specific network attack detection problems and their solutions in PURSUIT using various PPDM algorithms.

### 3.1.5.1. Recognizing Distributed Attack Signatures

PURSUIT will be designed to develop attack “signatures” based on the patterns collected from different coalition members. An attack signature can be characterized by several features such as the source IP, destination port, preferred protocol, length of connection, latency in connection (may indicate number of hops), and commands used inside of protocol type, frequency, and time (in some scenarios) of the probes launched during the attack.

Attackers usually do not use their own IP address, because it allows the attacker to be identified. Internet attacks usually connect through a series of hosts to hide their identity. Lets call this set of hosts the attacker uses their zombie network. Clever attackers vary the set of hosts used to conduct their attacks. However, by pooling information from different site, it is possible to associate a list of zombie hosts with the attack-signatures. build up signatures of hackers based only on the hosts in their zombie network. These signatures allow PURSUIT to identify the spatio-temporally evolving clusters of attacks with similar signatures and offer better perspective of the threats evolving at large.

PURSUIT is equipped with the technology for distributed privacy-preserving measurement of similarity between network events, based on attributes collected from different IDPS systems or flow data from routers. It makes use of distributed privacy-preserving clustering algorithms and other related techniques. Previous sections described some of these clustering algorithms. This algorithm is directly used for computing the attack signatures. The following section presents some of the preliminary experimental results.

### 3.1.5.2. Detecting Attack Trends on Coalition Members

Trend analysis is a natural step in understanding many time series data. Trend analysis can also be used to better understand the emerging types of attacks and their possible future courses. Even a simple intersection of the attack IPs observed during different time- frames can tell us about the trend of the attack patterns. We extend the clustering techniques used in the above attacker signature algorithm to detect attack trends on the coalition. By clustering both data recognized by local IDS systems as attacks, and data not classified as an attack, we were able to generate clusters that generalize the properties of attacks versus non-attacks. In addition, with the appropriate cluster generation we can further subdivide attacks into different categories. Using these cluster models, we can detect outliers, which represent suspicious activity.

Clusters are formed based on areas of locally higher density. By measuring the percentage in density change over time of these clusters we can show the trends occurring in the coalition. For example, if a particular cluster becomes significantly more dense in a very short period, it could represent a denial of service activity, or perhaps broad portscanning to detect vulnerable systems.

Clustering both “suspicious” data (as identified by local IDS systems) and non-suspicious data creates additional considerations. Because, in general, the volume of non-suspicious data is far greater than the suspicious data, the total volume of data requiring processing by privacy preserving clustering algorithms is far greater, requiring greater computing resources and significant bandwidth. These requirements can be mitigated by sampling the non-suspicious data to provide a representative sample of such data. This technique may also incorporate sampling of generated data in a new privacy-preserving representation based on a representative density model of the real local data. This data will result in comparable cluster measurements as if the clusters had been computed based on the real data, but the real data will not be revealed at any point, only the generated data. In addition, the sampled artificially generated data is significantly reduced in volume, making the computation much more tenable.

PURSUIT also offers various modeling capabilities based on privacy-preserving multivariate regression techniques for identifying parametric models of the trends in the attack cluster evolution.

### 3.1.5.3. Detecting Stealth Network Probes by Attacks and Worms

Existing IDS systems are generally quite capable of detecting obvious port scanning activity. More sophisticated port scanning algorithms that attempt to hide themselves, or their source, are less easily detected, newer IDS systems attempt to deal even with these attacks. The purpose in the PURSUIT system is not to provide functions that traditional IDS systems already have, but to develop a system that makes use of distributed data to enable detection of activity that would not otherwise be detected, and to make sure that the privacy of coalition members and their data is simultaneously protected.

A single port scanning event on a busy network may be very difficult to distinguish from regular traffic because IDS systems generally require events to rise above some threshold level in order to be classified as suspicious. However, if data is collected from multiple networks, and if an attacker is contemporaneously targeting machines on these different networks, it is possible to identify these events.

### Privacy Preserving Stealth Port Scan Detection Algorithm

Simple algorithms to detect port scanning activity generally observe incoming connections and increment a counter for each connection a source makes to a different IP/port combination within some time or connection window. More sophisticated algorithms use some log scaling method to avoid false positives. We make use of the existing IDS scoring schemes to calculate local scores for source IPs, and then sum the local scores to form a score across the entire coalition.

The IDS score we make use of are of the form, (based on research by Eric Eilertson, et al.[2][3]):

$${score}_{srcIP , destPort} = {\sum }_{∀ {flows}_{srcIP}} \frac{1}{1 + 1 gcount ( destIP , destPort )}$$

where count(destIP,destport) is the count of number of connections to the destination IP and destination port. flows_{srcIP} is a set of tuples containing the destination IP and destination Port reached by the particular source IP.

We extend this approach to a distributed model by calculating the summation of these local scores from each site s₁K sₙ to form the collective score for a particular source IP:

$${collective\_score}_{srcIP , destPort} = {\sum }_{i = 0}^{n} {\sum }_{∀ {flows}_{{s}_{i ,} srcIP}} \frac{1}{1 + 1 g count ( destIP , destPort )}$$

where flowsₛ_{_{i,}}_{srcIP} is a set of tuples containing the destination IP and destination Port reached by the particular source IP observed at site sᵢ.

In order to do this, we must compute the following: Given a coalition of sites {s₁, s₂,K,sₙ} each site sᵢ has a set Vᵢ={(score_{i,srcIP,destPort},srcIP,destPort)}. These sites must to compute an aggregate score for each source IP:

$${collective\_score}_{srcIP , destPort} = {\sum }_{i = 0 , ( {score}_{i , srcIP , destPort} , srcIP , destPort ) ∈ {V}_{i}}^{n} {score}_{i , scrIP , destPort}$$

This operation must be performed without revealing the value of score_{i,srcIP,destPort}, if (score_{i,srcIP,destPort},srcIP,destPort) ∈ Vᵢ or if (score_{i,srcIP,destPort},srcIP,destPort) ∉ Vᵢ. Site sᵢ will only have knowledge of Vᵢ and Ŵ={(collective_score_{srcIP,destPort},srcIP,destPort)}.

A secure sum algorithm is applied to compute the aggregate scores for each source IP in the union set.

$${r}^{ρ} = \{ {r}_{j} \vert j = 1 , K , \vert {s}^{ρ} \vert )$$

is initialized with random numbers ranging from 0 to the maximum possible score. The CAM agent will now transmit s,r^{ρ} to each site sᵢ. Each site sᵢ will add their local scores from Wᵢ to r^{ρ}. So, \hat{R}=score_sum(R,W). Site sᵢ then transmits \hat{R} to site s_{i′1}, where the process is repeated. Finally site sₙ transmits the final \hat{R} to the CAM Agent, who can then subtract the original R from \hat{R}. Ŵ represents the aggregate scores corresponding to the source IPs in \hat{V}. If the score for a particular source IP falls above a given threshold, that source is considered a scanner.

The algorithm to perform this operation requires a combination of secure sum and secure set union SMC algorithms. There are additional considerations in combining the two operations. We want to minimize the amount of information “leaked” from the coalition sites, and we also want to minimize computation and communication costs. Further refinement of this algorithm will focus on these goals.

### Algorithm 1 for Privacy Preserving Secure Portscan Detection:

### Step 1—Secure Set Union

Securely compute among sites sᵢ,i=1,K, n:

$$W = {Y}_{i = 1 , ( {score}_{i , srcIP , destPort} , srcIP , destPort ) ∈ {V}_{i}}^{n} srcIP , destPort$$

### Step 2—Secure Sum

Securely compute among sites sᵢ,i=1,K,n:

Ŵ={(collective_score_{srcIP,destPort},srcIP,destPort)|srcIP,destPort ∈ W}

### Privacy Discussion of Privacy-Preserving Distributed Portscan Detection Algorithms

In the above algorithm, the set of incoming IP addresses (of all traffic) for the entire coalition is revealed after step 1. Even though these IP addresses cannot be attributed to any particular coalition member, this algorithm still may reveal more information than is desirable for some coalitions. This is the reason the Privacy Preserving Distributed Portscan Detection Algorithm 2 is included below. However, this algorithm is simpler, and may be more scalable, although the privacy improvements of Algorithm 2 both add additional complexity in additional steps, but also somewhat reduce the complexity compared to this algorithm.

This algorithm is also susceptible to collusion as in the secure sum algorithm, described in Section 1.2.2.4. If the sites transmit in this order sᵢ₋₁→sᵢ→sᵢ₊₁, sites sᵢ₋₁ and sᵢ₊₁ may collude to learn the actual value v at site sᵢ. However, the secure sum operation can be modified to permute the transmission order with each calculation, and divide the local values into several rounds of summations using only a portion of the actual local value. If the number of rounds is r and the local value to be summed is v, v is divided into r portions of random size such that

$$v = {\sum }_{j = 1}^{n} {v}_{j} \cdot {v}_{j}$$

is transmitted in each of r rounds of separate secure sum computations. Finally the total sum is taken of each of the intermediate sums from each round. Because the transmission order is permuted in some regular manner for every round it is not possible to the actual value of v as long as some percentage of the sites can be trusted.

### Algorithm 2 for Privacy Preserving Secure Portscan Detection:

We also propose a second algorithm that will only reveal source IP addresses if they are above the threshold that indicates likely scanning activity. The essential idea behind this algorithm is that the secure union operation carries the associated scores with it, in such a manner that the aggregate scores can be calculated without revealing the associated source IP.

### Step 1—First Round of Secure Set Union

Each site sᵢ has a set of tuples T=(V, W) the source IP addresses and associated scores respectively. In the first round of the secure set union calculation, V is encrypted by each site using a commutative encryption scheme as in the previous algorithm. The same procedure is followed in this algorithm, except the commutative encryption algorithm is also applied to W, forming T′=(E(V), E(W)). T′ is then transmitted to the next site sᵢ₊₁, where the same operation is performed on T′ and the local T, the result transmitted to the next site. When each site has performed the commutative encryption algorithm exactly once on each set, the result is transmitted to the CAM Agent. The CAM Agent combines the tuples T₁′K Tₙ′ into a single multi-set, and performs a permutation on this union multi-set.

### Step 2—Reveal the Associated Scores

This is the point at which the algorithm diverges most significantly from the secure set algorithm. Instead of conducting this round of communication after removing duplicates in the aggregate Eⁿ(\hat{V}) to remove the commutative encryption operations, and reveal the completed set \hat{V} as in the previous algorithm. Instead find Ŵ without revealing \hat{V} (and before removing duplicates), in this round of communication each site sᵢ removes its encryption from Ŵ without removing it from \hat{V}. When the resulting Eⁿ(\hat{V}), Ŵ is completed, it is transmitted to the CAM agent. The scores associated with each of the duplicates in Eⁿ(\hat{V}) are then summed in the normal manner. There is no need for a privacy preserving summation, because the associated source IPs and sites are not known. The Eⁿ(\hat{V}) entries that have an associated score below some threshold are then removed.

### Step 3—Second Round of Secure Set Union

The Eⁿ(\hat{V}) with removed entries below a given threshold is then transmitted to each site sᵢ where the encryption is removed as in the normal secure union algorithm. Finally \hat{V} is revealed, but without the source IPs that fall below the threshold for the coalition.

### Performance Discussion of Privacy-Preserving Distributed Portscan Detection Algorithm 2

The second algorithm requires an additional round of communication to achieve its additional privacy protection. However, the vector in the final communication round is likely to be significantly smaller, as the non-scan activity has been removed. In addition, because it is not subject to the collusion attack on the secure sum operation there is no need to add additional rounds of communication to perform the secure sum.

### Privacy Discussion of Privacy-Preserving Portscan Detection Algorithm 2

Colluding sites present a problem to algorithms such as the secure sum operation; the second algorithm avoids these problems by not making use of the secure sum operation. However, some data is still leaked as in the previous algorithm, or in the secure set union in general. The count of duplicates is revealed, even for those that fall below some threshold, before they are purged. The data (source IP address and destination port) is not able to be associated with these counts however, minimizing the risk of such an information leak.

The use of the commutative encryption algorithm on the count in addition to the IP has the advantage of hiding from site sᵢ₊₁ the original counts from sᵢ, which would be revealed if the count were unencrypted. These counts are only revealed in the final stage, when the site that recorded the count can no longer be identified.

We believe that revealing the count of communication hits, given an unknown association with either the site experiencing the traffic, or with the source IP, does not represent a breach of privacy. We are pursuing further refinement to ideally eliminate any information leaks, however we are confident that this algorithm as is adequately protects the privacy of participating coalition members. A set of counts (of events) associated with unknown source IP addresses and unknown coalition members will not help an adversary to construct any unknown information about the coalition.

The only source IP addresses that are revealed by this algorithm are those that are identified as participating in port scanning activity. Since these are all external IP addresses, and likely engaged in malicious activity, revealing these IP addresses is reasonable given the privacy concerns outlined in the introduction. If a particular coalition member does not wish to reveal the identity of attacks, even when they are identified as such, the member may choose not to provide information to this algorithm. Because only source IP addresses that are believed to be port scanning are revealed in this algorithm, normal business partners of the coalition members engaged in normal activity will not be revealed.

The Stealth Network Probe Detection module of PURSUIT is also designed to distinguish probes by Internet worms from probes performed by attackers. Worms generally scan the Internet in some random fashion, and hackers target a particular organization or sector. The distinction can be identified by comparing the set of locally detected scans with the set of scans detected within the whole coalition. Further heuristics can be used to reduce the number of false positives based on time and connection window information, frequency count, etc.

### 3.1.5.4. Computing Attack Patterns and Statistics for Coalitions

This module of PURSUIT computes various coalition-level attack patterns and statistics. Currently it is difficult to detect attack statistics on a class of targets critical for national infrastructure. For example, it would be very important to know if the power companies were the focus of an attack.

PURSUIT computes associations, outliers, clusters, and other models capturing the cross-domain attack patterns and statistics using PPDM algorithms. These individual patterns are tagged based on the type of the source organization (e.g. power company, defense agency). A frequency distribution of the attacks based on the type of the attacked organization (obtained from the registration information provided while joining the coalition) provides wealth of information for detecting any emerging threats against a critical infrastructure.

Locally run IDPSes are reasonably successful at detecting attack patterns, but there is potential for a significant improvement if these algorithms have access to additional information. Correlation of information from multiple sites can lead to new knowledge that cannot be obtained from just local analysis. Additionally, information from other sites can improve the quality of analysis at local sites. For example it can result in increased precision and recall for detecting cyber attacks using centralized tools. It can also improve the output of clustering and anomaly detection. By taking information from multiple sites it is possible to develop a clearer picture about just who the bad guys are on the Internet.

By correlating information we could obviously get a better coverage of how many attackers there are, and who they are, by combining data collected from multiple sites and creating a similar picture. But more interestingly we can create an inverse view, that is, where this attacker is. If the targets are distributed all over the picture it can be reasonably inferred that this is either a worm, or someone aiming randomly with no real agenda. However, if the attacks are constrained to certain regions of the destination IP space, it would be reasonable to infer that the attacker does have an agenda.

This approach could be used to detect distributed attacks against an organization, or against a particular type of organization. One could look for IP addresses that only made (or made a majority of) connections to the IP address space of certain types of organizations.

One simple way to visualize this is to have two figures, one containing the destination IP addresses, the other source IP addresses. The plots would dynamically show the connections based on a user-defined address space filter.

Local analysis can be augmented with cross-domain analysis. A simple example involves taking the list of hostile IP addresses detected within the coalition and giving them a higher weight when performing clustering or anomaly detection. A more difficult task involves determining which features were useful in detecting some type of interesting behavior at one site or the coalition, and then giving higher weight to these features at another site to improve clustering or anomaly quality.

### Privacy Preserving Distributed Clustering Algorithm for Network Data Segmentation

Segmentation of the network threat data can be useful for many reasons. For example, we may want to identify the different network-attack types and their impact on a network. PUSUIT makes use of privacy-preserving clustering algorithms for network threat data segmentation. These clustering algorithm analyzes the network attach data and returns a set of partitions of the data where each partition may correspond to a class of network threat behavior.

PURSUIT makes use of a privacy-preserving distributed version of a k-means clustering algorithm. The k-means clustering algorithm operates as follows. k points are randomly selected in the feature space. Every item in the set of objects is assigned to one of these k points based on the smallest distance measure (which can be computed in any number of ways; Euclidian, Manhattan, etc.). The new median of each of these clusters is recomputed based on the points that are assigned to it. The algorithm continues iterating assignment of objects and re-computing of clusters until the amount of change in the median of k clusters falls below some minimum threshold.

The privacy preserving k-means algorithm over horizontally partitioned data operates in the same manner, except the objects are distributed across multiple sites, here {s₁,s₂,K,sₙ}. The resulting cluster means (known as centroids) are computed without revealing the actual objects, or what the contribution of each site is to the total set of all objects in the computation.

### Algorithm: DPC1

### Step 1—Generate Starting Centroids

k initial points are generated randomly by the CAM Agent. This set of initial points is transmitted to each of the sites.

### Step 2—Compute Local Centroid Assignments

At each site, sᵢ, the local objects T are assigned to the appropriate centroid Aᵢ based on the distance metric selected. The sites perform this operation in parallel.

### Step 3—Compute Distances

At each site, sᵢ, new means are computed based on the assigned local objects. The number of points contributing to the mean, as well as the summation of the object distances is computed. Again, this computation is performed in parallel.

### Step 4—Compute Means for Coalition

This step makes use of secure sum algorithms. The sum of the local means is computed, separately summing each attribute, as well as the number of objects. The secure sum algorithm is initiated by the CAM Agent. The CAM Agent creates

$$V = \{ \vert i = 0 , K , k , j = 0 , K , {num}_{attributes} \} and$$

$$= \{ {c}_{i} \vert i = 0 , K , k \} .$$

Each xᵢⱼ is initialized with random values, and each cᵢ is initialized with a random value greater than the maximum number of objects the coalition could have. V and [symbol] are then sent to site s₁. s₁ computes

$${V}_{ij}^{′} = {V}_{ij} + {\sum }_{l = 0}^{\vert {T}_{i} \vert} dist ( {A}_{ij} , {T}_{ijl} )$$

and cᵢ′=cᵢ+|Tᵢ| for all i,i=0,K,k and j,j=0,K,num_{attributes}. V′ and [symbol] are then sent to sᵢ and sᵢ performs the same computation. This operation is performed synchronously by each site, sᵢ. When completed, the final V′ vectors and [symbol] values are transmitted to the CAM agent, which can subtract the original V and [symbol] so that the new mean values can be calculated.

### Step 5—Calculate Termination Condition

If the new calculated means differ from the previous computed means, the means are accepted and the computation is completed. If not, the new means are transmitted as in step 1, and the cycle is repeated.

### Algorithm: DPC2

This section discusses an additional algorithm for distributed, privacy-preserving data mining algorithm for network threat data segmentation. The approach is very different from the algorithm described in the previous section. This approach is fundamentally based on capturing the local clustering using parametric and non-parametric techniques in a privacy-preserving representation, exchanging the cluster distributions among the different nodes, and generating global clusterings based on these cluster descriptions. The steps are further discussed in the following:

### Step 1: Construct Similarity Preserving Representation of the Data at Each Node

This step constructs a new similarity preserving representation of the data. Such representation can be constructed using various techniques such as application of a random orthonormal transformation. This particular transformation preserves inner product which in turn makes sure that the pairwise Euclidean distance is maintained. In order to apply this step the network threat data is usually grouped in two different subsets - - - (1) real valued features and (2) discrete valued features. The real valued feature columns are directly suitable for such similarity preserving transformations. Discrete attributes can also undergo such transformations after going through a similarity preserving embedding in real domain.

### Step 2: Local Clustering and Cluster Description Generation

This step performs local clustering at each site and generates descriptions of the clusters using parametric and non-parametric techniques. This step does not necessarily require using any specific clustering algorithm. Any clustering algorithm can be used for this purpose. The clustering algorithm is run on the data transformed into the new similarity preserving representation constructed in Step 1. A description of these clusters can be generated using various techniques. For example, a histogram can be used to capture the distribution of the data in each of the clusters. On the other hand, parametric techniques such as multinomial distributions can be used to capture the distribution of data.

### Step 3: Cluster Description Sharing and Global Clustering

This step involves sharing the cluster descriptions among different participating nodes and merging those descriptions in order to generate the global clusters. For example, multiple histograms can be easily combined in order to generate a single global histogram. Similar technique can be applied parametric descriptions like multinomial distributions.

Privacy-Preserving Distributed Anomaly Detection from Network Threat Data

This section describes a distributed, privacy-preserving anomaly detection algorithm for detecting outlier behavior in a cross-domain network. The approach exploits a privacy-preserving version of k nearest neighbor computation technique. It assigns a score to every observed network flow data tuple based on the number of nearest neighbors. The scores are combined across multiple sites using secure privacy-preserving sum computation techniques. The combined score is then used to identify the global outliers. Each of the steps is further explained below.

### Step 1: Construct Similarity Preserving Representation of the Data at Each Node

This step constructs a new similarity preserving representation of the data. Such representation can be constructed using various techniques such as application of a random orthonormal transformation. This particular transformation preserves inner product which in turn makes sure that the pairwise Euclidean distance is maintained. In order to apply this step the network threat data is usually grouped in two different subsets - - - (1) real valued features and (2) discrete valued features. The real valued feature columns are directly suitable for such similarity preserving transformations. Discrete attributes can also undergo such transformations after going through a similarity preserving embedding in real domain.

### Step 2: Compute Nearest Neighbors Across Multiple Sites

This step makes use of secure inner product computation algorithms discussed earlier in order to compute the pair-wise Euclidean distance between data tuples. If the distance is less than a certain threshold then the tuple is considered to be a neighbor. Total number of such neighbors is counted.

### Step 3: Global Anomaly Score Computation

An anomaly score is assigned to each data tuple based on the number of its neighbors. The scores from each node may also be aggregated using privacy preserving secure sum technique. If the score is less than a threshold value then the tuple is labeled anomalous.

1. A multi-agent, privacy-preserving distributed data mining apparatus for combining network-attack patterns detected by multitude of network sensors such as firewalls, virus-scanners, and intrusion detection systems. This apparatus has the following components:
a. PURSUIT Agent: This module runs at each participating node of the distributed environment. It connects to the local network sensor and collaboratively computes the global patterns using privacy-preserving, distributed data mining algorithms.
b. LIP Agent: This module interfaces the PURSUIT agent at each participating node with the network monitoring sensor. This offers various plug-in-s for different sensors.
c. CAM Agent: This module is in charge of coordinating the distributed computation of privacy-preserving data mining algorithms performed by the PURSUIT agents. The CAM agent also provides the collectively computed statistics to the PURSUIT web services.
d. PURSUIT Web Services: Results of the privacy-preserving analysis of the data monitored by a multitude of PURSUIT agents are presented through a web-service. Users can use any web browser to login to the PURSUIT web account and access the information generated by distributed privacy-preserving network threat data mining algorithms.

2. The apparatus of claim 1, further comprising a privacy management module.

3. The apparatus of claim 1, further comprising a distributed data mining module.

4. The apparatus of claim 1, further comprising a distributed collaboration management module for network threat detection and prevention.

5. The apparatus of claim 1, further comprising a module for distributed privacy policy management module.

6. The apparatus of claim 1, further comprising a module for distributed privacy-preserving collaborative network threat analysis.

7. The apparatus of claim 1, comprising of a module for distributed, multi-party, privacy-preserving port scan detection technique that allows detection of network attacks in multiple networks without sharing the network traffic with each other.

8. The scan detection technique of claim 8 compares the attack data using secure, privacy-preserving, multi-party computation-based data mining algorithms.

9. A distributed, multi-party, privacy-preserving technique for detecting common worm attacks in multiple networks without sharing the network traffic with each other.

10. A distributed, multi-party, privacy-preserving technique for identifying geo-spatial location of network attackers against multiple networks over a time period without sharing the network traffic with each other.

11. A distributed, multi-party, privacy-preserving algorithm (DPC1) for performing privacy-preserving clustering from network data in multiple networks without sharing the raw network traffic data with each other.

12. A distributed, multi-party, privacy-preserving algorithm (DPC2) for performing privacy-preserving clustering from network data in multiple networks without sharing the raw network traffic data with each other.

13. A distributed privacy-preserving network threat data segmentation algorithm based on distributed, privacy-preserving clustering algorithms.

14. A distributed, multi-party, privacy-preserving technique for computing a similarity-preserving representation of IP addresses and other network parameters and computing functions from this information collected in multiple networks without sharing the network traffic with each other.

15. A framework of privacy-preserving data mining, called k-zone of privacy that constructs a new representation of the data which do not allow others to perform a one-to-one inverse transformation for breaching the privacy of the data.

16. The apparatus of claim 1 comprising of all algorithms mentioned in claim 9 to claim 15.

17. The apparatus of claim 1, further comprising a module for web-based graphical user interface for presenting the results of all distributed, privacy-preserving analysis of the network data from different sources mentioned in claim 7 to claim 15.

18. The apparatus of claim 1, connecting different virus scanners, firewalls, intrusion detection, and intrusion prevention systems.

19. The apparatus of claim 1, connecting host-based and network-based intrusion detention and intrusion prevention systems.

20. The apparatus of claim 1, supporting formation of ad-hoc peer-to-peer, hierarchical, and other collaborative coalitions.
